(19) United States
(12) Patent Application Publication
(10) Pub. No.: US 2007/0227460 A1
(43) Pub. Date: Oct. 4, 2007

(54) Stackable bird cage

(75) Inventor: John P. Lynch, Burbank, SD (US)

Correspondence Address: MERCHANT & GOULD PC, P.O. BOX 2903, MINNEAPOLIS, MN, 55402-0903, US

(73) Assignee: Sydell Incroporated

(21) Appl. No.: 11/454,443

(22) Filed: Jun. 15, 2006

Related U.S. Application Data
(60) Provisional application No. 60/744,065, filed on Mar. 31, 2006.

(51) Int. Cl. A01K 31/06

(52) U.S. Cl. 119/455

(57) ABSTRACT

A stackable cage for use with birds and animals. The stackable cage includes a ventilated enclosure having a door. The enclosure includes a bottom and a top. Each of the bottom and top having corresponding structure that interlocks with the structure of stacked cages to securely maintain the stacked relationship of the cages. The bottom of the enclosure also includes a raised floor at least partially surrounded by a channel. Bird or animal droppings migrate toward the channel to reduce the mess associated with housing animals or birds.

### CROSS-REFERENCE TO RELATED APPLICATIONS

This application claims the benefit of U.S. Provisional Application No. 60/744,065, filed on Mar. 31, 2006; which application is incorporated herein by reference.

### TECHNICAL FIELD

The present disclosure relates generally to devices for use in the animal industry, and various methods associated with such devices. More particularly, the present disclosure relates to a cage that can be used to house or transport small animals and birds.

### BACKGROUND

Producers of small animal livestock and larger game birds or poultry often utilize hand-carrying crates or cages for the transport of the livestock and birds. Conventional transport cages typically include a frame that supports ventilated material or ventilated sides. In some bird industries, such as the poultry industry, such cages include a top door for loading the birds (i.e., chickens) into the cage. In the wild game bird industry, caging and transport enclosures are limited; and wild game bird producers left with only the top-loading cages more suitably adapted to the poultry industry. In general, improvement has been sought with respect to such cage devices, and in particular, cage devices for use in the game bird producing industry, generally to better accommodate ease of use in housing and transporting wild game birds.

### SUMMARY

The present disclosure relates to a stackable cage, and associated methods of using stackable cages. The stackable cage generally includes a ventilated enclosure having a top and a bottom. The top includes a recessed perimeter, and the bottom includes guide structure. The guide structure of one stackable cage is positionable within the recessed perimeter of another cage to secure the cages in a stacked relationship. The stackable cage further includes vertical reinforcing channels that accommodate and support the weight of stacked cages. The stackable cage further includes a door located on the side of the ventilated enclosure. The door permits access to the interior of the cage, even when other cages are stacked upon the cage.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a front perspective view of one embodiment of a stackable cage according to the principles of the present disclosure;

FIG. 2 is a cross-sectional view of the stackable cage of FIG. 1, taken along line 2-2;

FIG. 3 is a cross-sectional view of the stackable cage of FIG. 1, taken along line 3-3;

FIG. 4 is a rear perspective view of a number of stackable cages, shown in a stacked relationship;

FIG. 5 is a cross-sectional view of another embodiment of a stackable cage according to the principles of the present disclosure; and

FIG. 6 is a schematic representation of a platform that can be used to transport the stacked cages of FIG. 4.

### DETAILED DESCRIPTION

Reference will now be made in detail to various features of the present disclosure that are illustrated in the accompanying drawings. Wherever possible, the same reference numbers will be used throughout the drawings to refer to the same or like parts.

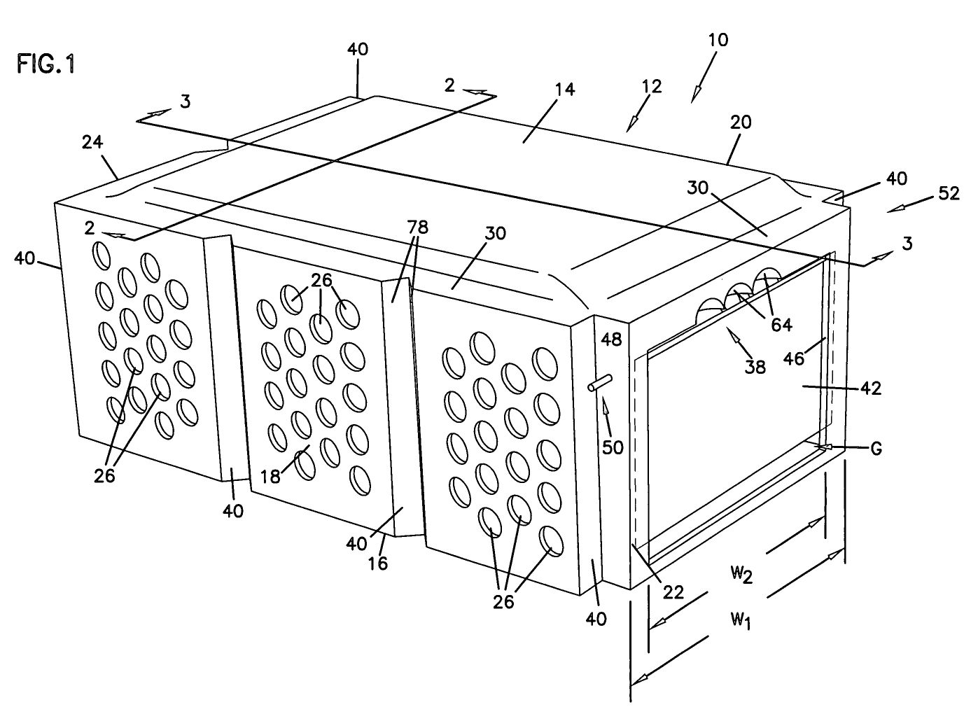

FIGS. 1-6 illustrate various embodiments of a stackable cage having features that are examples of how inventive aspects in accordance with the principles of the present disclosure may be practiced. Preferred features are adapted to accommodate ease of housing and transportation of large birds. In one application, the stackable cages are particularly useful for housing and transporting wild game birds, such as pheasants, for example. It is to be understood that the presently disclosed stackable cage can also be used to house and transport other birds and other small animals.

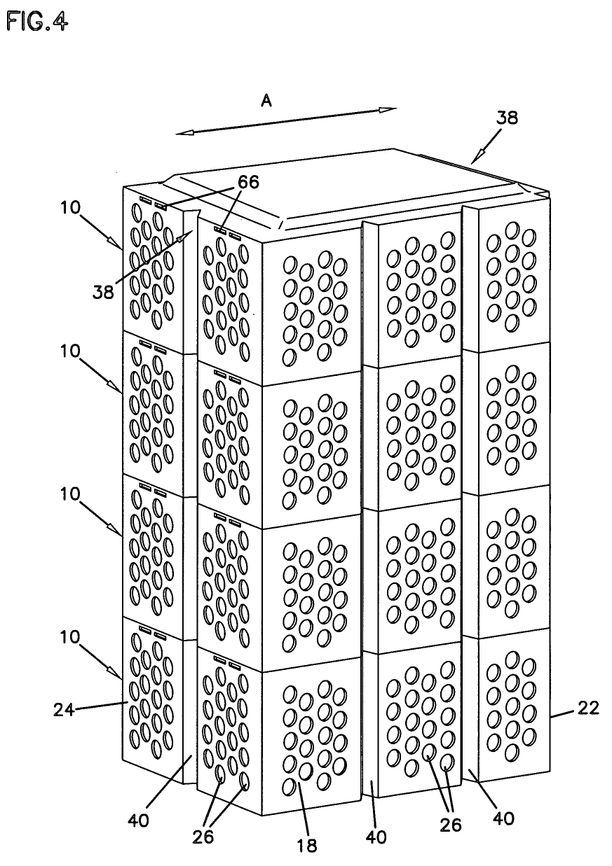

Referring now to FIG. 1, one embodiment of a stackable cage 10 is illustrated. The stackable cage 10 includes an enclosure 12 having an interior. The interior is defined by a top 14, a bottom 16, and sides 18, 20, 22, 24. The sides include first and second opposing sides 18, 20, and first and second opposing ends 22, 24. In the illustrated embodiment, ventilation holes 26 are provided in each of the first and second opposing sides 18, 20 and the second end 24 (FIG. 4) of the enclosure 12.

The ventilation holes 26 can be sized and shaped in a variety of configurations, depending upon the user's needs. For example, the holes can range in size from ¼ inch in diameter to 1.0 inch in diameter depending upon the size of the bird or animal; and further depending upon the period of time that the bird or animal will remain in the cage.

In a preferred embodiment, the stackable cage 10 is constructed of polyethylene or any other non-corrosive material. In the illustrated embodiment, the cage is made of a material manufactured with generally smooth interior surfaces, as opposed to rough or porous surfaces. The smooth interior surfaces of the stackable cage 10 are easy to clean and help to prevent bacteria from attaching to the surfaces, in contrast to conventional wooden surfaces, for example. The smooth interior surfaces reduce the spread of bacterial illnesses, such as Bird Flu, for instance.

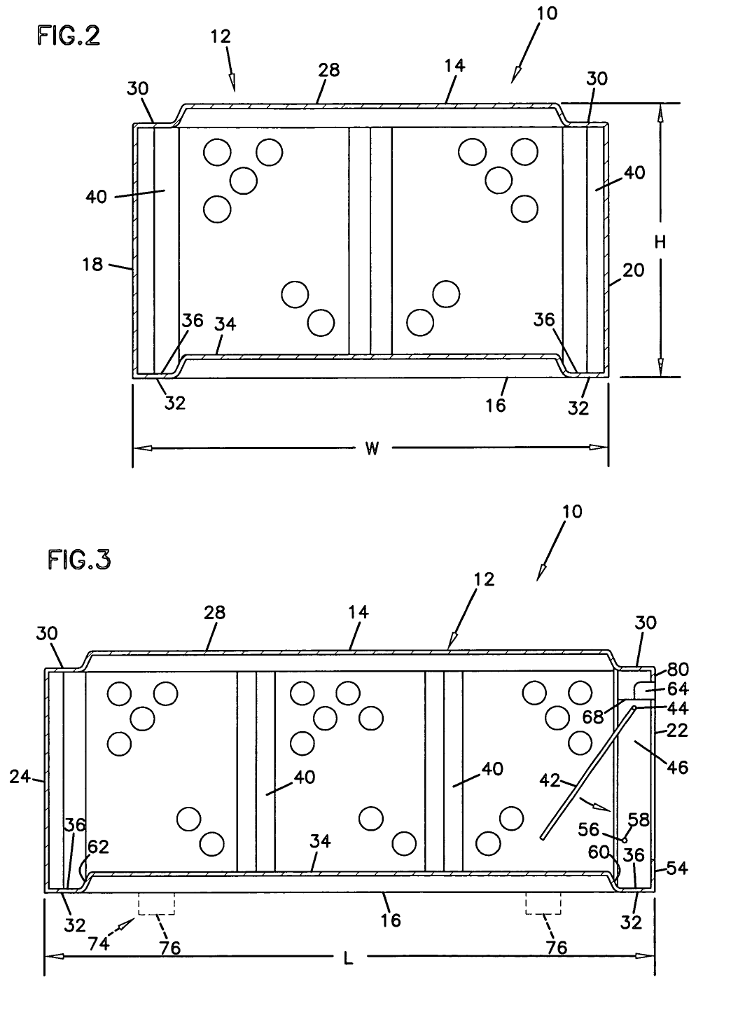

In general, the cage 10 has an overall length L (FIG. 3), an overall width W (FIG. 2), and an overall height H (FIG. 2); although the disclosed principles can be applied in a variety of sizes and applications. The width W of the cage 10 is generally defined between the first and second opposing sides 18, 20, and is preferably between about 12 and 20 inches; more preferably between about 14 and 18 inches. The height H of the cage is generally defined between the top 14 and the bottom 16, and is preferably between about 6 and 14 inches; more preferably between about 8 and 12 inches. The length L of the enclosure is generally defined between the first and second opposing ends 22, 24, and is preferably between about 16 and 32 inches; more preferably between about 20 and 28 inches. In the illustrated embodiment, the cage has a width W of about 16 inches, a height H of about 9.5 inches, and a length of about 24 inches.

Referring now to FIGS. 1-3, the top 14 of the enclosure 12 includes a chamfered or recessed perimeter 30 that surrounds a raised top surface 28. The bottom 16 of the enclosure includes guide structure 32 (FIGS. 2 and 3) sized and arranged to correspond to the chamfered or recessed perimeter 30 of the top 14. In use, when two or more cages 10 are stacked, the guide structure 32 of the bottom 16 of one cage seats within the recessed perimeter 30 of another cage to secure the two cages in a stacked relationship.

Referring now to FIGS. 2 and 3, the bottom 16 of the enclosure 12 defines a raised floor 34. The raised floor 34 is at least partly surrounded by an interior channel 36. The interior channel 36 also forms or defines the guide structure 32 of the enclosure 12. In the illustrated embodiment, the interior channel 36 completely surrounds the raised floor 34. The raised floor 34 and interior channel 36 enhance the overall cleanliness of the disclosed stackable cage 10. In particular, the raised floor 34 allows animal droppings to migrate toward and into the interior channel 36 where the droppings are retained away from the raised floor. The feature reduces the mess associated with housing and transporting small animals and birds.

As shown in FIG. 3, the raised floor 34 of the enclosure 12 includes a chamfered or beveled front edge 60 and a chamfered or beveled rear edge 62. The beveled edges 60, 62 permit a user to more easily slide the cage rearward or forward (as represented by double arrow A in FIG. 4) in relation to a lower cage when stacking or un-stacking cages. For example, in contrast, if the edges 60, 62 of the raised floor 34 where squared, a user would be required to lift a seated upper cage from a lower cage. In addition, if an upper cage were slid along the top of a bottom cage, a squared seating arrangement would create a jarring affect when the upper cage dropped into the seated position; such jarring can frighten the birds housed within the cage. The tapering surfaces of the beveled edges 60, 62 of the present enclosure 12 provide a transition that reduces the jarring affect when stacking cages. The overall arrangement of the guide structure 32 and the raised floor 34 with beveled edges 60, 62 allows the cage 10 to easily slide forward and rearward, and more gently seat in a stacked relationship.

In use, the total weight of a loaded cage, i.e. a cage containing small animals or large birds, can be over 30 lbs. Referring back to FIG. 1, to accommodate the stacked weight of multiple cages, the present cage 10 includes reinforcement constructions 40. The reinforcement constructions 40 are formed in the sides of the enclosure 12, and in each of the corners of the enclosure. In the illustrated embodiment, each of the opposing sides 18, 20 includes two reinforcement constructions 40, while the second end 24 of the enclosure includes one reinforcement construction 40 (FIG. 4). As can be understood, the enclosure 12 can include other placement configurations and other quantities of reinforcement constructions to accommodate particular uses.

In the shown embodiment, the reinforcement constructions 40 include vertical reinforcing channels molded into the sides and corners of the enclosure 12. The vertical reinforcing channels are configured and arranged to support the weight of at least seven stacked cages; the stack height generally being no greater than a user's arm reach—about eight cages in height. In the illustrated embodiment, the vertical reinforcing channels include vertical angled sides 78 (FIG. 1) that structurally reinforce the enclosure 12; although other reinforcement configurations can be used.

Still referring to FIG. 1, the present cage 10 includes a door or gate 42 preferably located in one of the sides 18, 20, 22, 24 of the enclosure 12. In the illustrated embodiment, the door 42 is positioned at an opening 46 located at the first end 22 of the enclosure 12. The door 42 provides side access to the interior of the cage 10. A reinforced header 80 (FIG. 3) is located above the door opening 46 to aid is supporting the weight of stacked cages.

As shown in FIG. 3, the door 42 is a hinged door the pivots inward toward the interior of the enclosure 12. The hinged door 42 is connected to a rod 44 that attaches to the first end 22 of the enclosure 12 at first and second pivot locations 50, 52 (FIG. 1). The pivot locations 50, 52 are located such that ends 48 (only one shown in FIG. 1) of the rod 44 are positioned in the vertical reinforcing channels 40 formed at the corners of the enclosure. By this arrangement, the rod 44 does not extend beyond the overall width W of the cage 10, so as to not interfere with side stacks or side placement of adjacent cages. The pivot locations 50, 52 of the hinged door 42 are located in the sides 18, 20 of the enclosure, as opposed to the top or bottom, for example, so as to also not interfere with the stackability of the cage 10.

Still referring to FIG. 3, the hinged door 42 closes automatically after an animal or bird has been loaded or inserted into the enclosure 12. In the illustrated embodiment, the hinged door 42 closes by gravity, however, a spring can also be used to bias the door to a closed position. As shown in FIG. 1, the door 42 has a width W1 (shown in dashed lines) that is greater than a width W2 of the opening 46. Accordingly the opening 46 acts a stop so that the door 42 cannot open in an outward direction.

Referring back to FIG. 3, a lip 54 is located adjacent to the bottom 16 of the enclosure at the opening 46. The lip 54 prevents bird or animal droppings located within the cage from falling out during transport; and ensures that the bird's or animal's feet will not stick out and possibly become injured.

As shown in FIG. 1, the lip 54 is also arranged in relation to the door 42 such that a clearance gap G is provided therebetween. Preferably, the clearance gap G is sized to prevent a user's fingers from getting caught between the door 42 and the enclosure 12 (i.e. the lip 54) when placing animals or birds in the cage. The clearance gap G can be between about 0.5 inches and 1.5 inches in height. In the illustrated embodiment, the clearance gap G is approximately 0.75 inches.

In one embodiment, a hole 56 is provided in the enclosure 12 adjacent to the door 42. A pin 58 can be inserted into the hole 56 to secure the door 42 in a closed position. In particular, the pin 58 can be inserted into the hole 56 so that the pin 58 extends into the opening 46 to capture the door 42 between the pin 58 and the opening 46. A securing pin and hole arrangement can be located on both sides of the door 42. In the alternative, a magnetic plate (not shown) and corresponding door closer can be position on the door 42 and the enclosure 12 (such as on the lip 54) to secure the door 42 in a closed position.

Referring back to FIG. 1, the illustrated door 42 is a solid construction. That is, the door 42 does not include ventilation holes (e.g. 26). In alternative embodiments, the door 42 may include ventilation holes where, for example, the climate requires additional ventilation. Preferably, however, the door 42 is a solid construction so that the wings or feet of birds, for example, do not catch in the holes of the door when the birds are being placed within the cage.

In the preferred embodiment, the cage 10 includes carrying structure 38 (FIGS. 1 and 4) that permits a user to easily grasp and lift the cage when stacking or carrying the cage. In the illustrated embodiment, the carrying structure 38 includes finger openings 64 (FIGS. 1 and 3) formed in the first end 22 of the enclosure adjacent to the door opening 46, and recesses or holes 66 (FIG. 4) formed in the second end 24 of the enclosure. The finger openings 64 and the holes 66 allow a user to easily grasp, lift, and carry the cage 10. In the alternative, the pivot locations 50, 52 for the door 42 can be located a distance below a top edge 68 (FIG. 3) of the opening 46 such that an open slot is formed. The open slot can also be used to grasp, lift, and carry the cage 10.

As previously described, the cage 10 is designed such that two or more cages can be securely stacked upon one another. FIG. 4 illustrates multiple cages 10 positioned in a stacked relationship. In the stacked relationship, the guide structure 32 (FIG. 2) of an upper cage seats within the recessed perimeter 30 of a lower cage. The raised top surface 28 of the enclosure 12 prevents the seated upper cage from shifting relative to the lower cage.

In a preferred embodiment, the top 14 and the bottom 16 of the enclosure 12 are a solid construction. That is, the ventilation holes 26 of the enclosure 12 are provided only in the sides of the cage. The solid construction of the top 14 and bottom 16 prevents animal droppings produced in an upper cage from falling through into a lower cage. This feature also enhances the overall cleanliness of the disclosed stackable cage 10.

Further, cages having holes in the bottom can cause injury to the birds or animals placed in the cages. The bird's or animal's feet can stick out through the holes and can become severed when the cages are stacked. In addition, wild birds and small animals placed in cages often attempt escape through the top of the cage. Cages having holes in the top of the cage can cause head damage and/or damage to the feathers of birds. Feather damage can be critical to birds whose feathers distinguish the male or female characteristics of the bird. Feather damage is also critical when the birds are being displayed for show.

With regards to feather damage, in some application it is desirable to provide ventilation holes only along the upper region of the first and second opposing sides 18, 20 and the second end 24 (FIG. 4) of the enclosure 12. This is especially applicable to delicate birds having feathers that need protection. The lower region of the first and second opposing sides 18, 20 and the second end 24 of the enclosure 12 can then be manufactured with smooth inner surfaces so that the tail feathers, for example, of such delicate birds do not become damaged.

Because of the location of the door 42, the interior of each of the cages 10 can be accessed while the cages 10 are in a stacked relationship. In conventional arrangements, the cages often have doors located in the top of the cage. To access the interior of such a cage located at the bottom of a stack, the upper cages must be unstacked. With the present stackable cage 10, animals or birds are side-loaded into the cages; which permits a user to load or access the animals or birds while the cages are stacked.

The stacked cages are securely seated in the stacked relationship such that the stack of cages can be transported in the stacked relationship, as shown in FIG. 4. Transportation structure 74 (FIG. 5) can be provided to more easily transport the stack of cages. In the embodiment shown in FIG. 5, the transportation structure 74 is formed as part of the cage 10. The transportation structure 74 includes a centrally located slot 70 sized and arranged to receive the base plate of a dolly, for example. The centrally located slot 70 is formed in the bottom 16 of the enclosure 12. The base plate of the dolly can be inserted within the slot 70, and the stack of cages transported from one location to another.

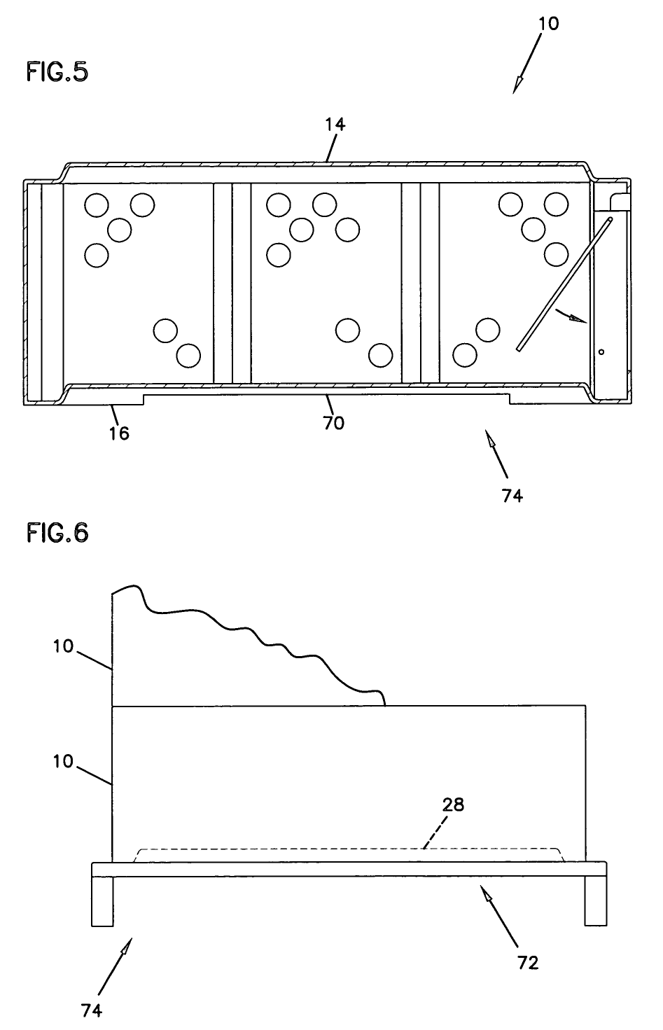

In the alternative, the transportation structure 74 can be a separate construction from that of the cage 10. As shown in FIG. 6, the transportation structure 74 can include a transport platform 72 constructed to receive the base plate of a dolly. The stacked cages 10 can be placed on the transport platform 72, which may include similar top structure (e.g. a raised top surface 28) as that of a cage to function as a “starter cage” of a stack of cages. Yet further in the alternative, the transportation structure 74 can include cross-runners 76 (shown in dashed lines in FIG. 3). The cross-runners 76 can be attached to a cage 10 that will serve as the base cage of a stack of cages. The cross-runners 76 are spaced to receive the dolly base plate.

In each of the previously described embodiment, the transportation structure 74 is described in association with a dolly. It is to be understood that other mechanisms of transport, such as a forklift or cart, can also be used; and that the transportation structure can be constructed in various ways to accommodate the carrying structure of the other mechanisms of transport.

The above specification provides a complete description of the present invention. Since many embodiments of the invention can be made without departing from the spirit and scope of the invention, certain aspects of the invention reside in the claims hereinafter appended.

What is claimed is:

1. A stackable cage, comprising:
a) a ventilated enclosure including a top, a bottom, and sides extending between the top and the bottom, the top, bottom and sides defining an interior, the top including a recessed perimeter, the bottom including guide structure; and
b) a door positioned at one of the sides of the enclosure to permit side access to the interior of the enclosure;
c) wherein the guide structure of the bottom is sized and arranged to correspond to the recessed perimeter of the top such that when two or more cages are stacked, the guide structure of the bottom of one cage seats within the recessed perimeter of another cage to secure the stacked relationship of the two or more cages.

2. The cage of claim 1, wherein the bottom of the ventilated enclosure defines a raised floor at least partly surrounded by an interior channel.

3. The cage of claim 1, wherein at least two opposing sides of the ventilated enclosure define reinforcement constructions arranged to support the weight of stacked cages.

4. The cage of claim 3, wherein the reinforcement constructions include vertical support channels formed in the at least two opposing sides.

5. The cage of claim 1, wherein the door is a hinged door that pivots inward toward the interior of the ventilated enclosure.

6. The cage of claim 5, wherein the hinged door pivots about pivot locations, the pivot locations being provided in the sides of the ventilated enclosure.

7. The cage of claim 1, wherein the ventilated enclosure has a length of approximately 24 inches, and a width of approximately 16 inches.

8. The cage of claim 1, wherein the bottom of the ventilated enclosure defines a slot, the slot being sized for receipt of a dolly for transport of the cage.

9. A method of using stackable cages, the method comprising the steps of:
a) providing a first enclosure, the first enclosure including a recessed perimeter formed in a top of the first enclosure;
b) stacking a second enclosure on the top of the first enclosure, the step of stacking including positioning guide structure, formed on a bottom of the second enclosure, within the recessed perimeter of the first enclosure, each of the first and second enclosures including reinforcement constructions arranged to support the weight of stacked enclosures; and
c) transporting the stacked first and second enclosures.

10. The method of claim 9, further including accessing the interiors of each of the first and second enclosures while stacked.

11. The method of claim 9, further including loading birds into the interiors of each of the first and second enclosures.

12. The method of claim 11, wherein the step of loading birds includes side-loading the birds into the interiors of each of the first and second enclosures.

13. The method of claim 12, wherein the step of loading birds includes pivoting a hinged door inward toward the interior of the enclosure.

14. The method of claim 9, wherein the step of transporting the stacked first and second enclosures includes positioning a dolly within a slot formed in the bottom of the first enclosure.

15. The method of claim 9, wherein the step of transporting the stacked first and second enclosures includes providing a transport platform and stacking the first enclosure on the transport platform.

16. The method of claim 9, wherein the step of transporting the stacked first and second enclosures includes attaching cross runners to the first enclosure.
